(19) United States
(12) Patent Application Publication
(10) Pub. No.: US 2007/0067762 A1
(43) Pub. Date: Mar. 22, 2007

(54) Exposing code contentions

(75) Inventors: Brandon Scott Wadsworth, Redmond, WA (US); Roberta Diane Law, Redmond, WA (US); Michael V. Stanton, Woodinville, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/232,570

(22) Filed: Sep. 22, 2005

(51) Int. Cl. G06F 9/45; G06F 9/44

(52) U.S. Cl. 717/149; 717/127

(57) ABSTRACT

Code contentions among concurrently executing execution paths may be identified by intentionally altering the timing of execution of one or more modules of executable instructions in one of the execution paths.

### BACKGROUND

Applications, programs, functions, and other assemblies of programmable and executable code that use physical and logical resources may be modularized. These separate modules may include separate entities such as methods, classes, DLLs (dynamic link libraries), frameworks, etc., that may utilize common physical and/or logical resources. Further, concurrently executing threads of such modularized code may produce code contentions.

### SUMMARY

A code contention among two or more concurrently executing execution paths may be identified by intentionally perturbing execution of one or more modules of executable instructions in one of the execution paths, and creating a comprehensive profile of the execution of the concurrently executing execution paths at or near the time of the perturbance.

### DESCRIPTION OF THE DRAWINGS

The present description references the following figures.

FIG. 1 shows devices communicating over a network, with the devices implementing example technologies for at least identifying potential code contentions.

FIG. 2 shows an example of an execution environment for implementing example technologies for at least identifying potential code contentions.

FIG. 3 shows an example of a tool for at least identifying potential code contentions.

FIG. 4 shows an example thread to which a tool for at least identifying potential code contentions may be applied.

FIG. 5 shows an example processing flow for at least identifying potential code contentions using the example tool of FIG. 3.

### DETAILED DESCRIPTION

Tools, contracts, and collaborative processes for at least identifying potential code contentions are presently described.

The contracts and collaborative processes for at least identifying potential code contentions, as described herein, may relate to tools, systems, and processes for delaying one or more modules of executable code within a thread to thereby expose any potential contentions (e.g., race conditions) with one or more modules of executable code within a concurrently executing thread. Further, such tools, systems, and processes may be implemented in one or more devices, or nodes, in a network environment.

“Assembly,” as described herein, may refer to a unit of deployment or, more particularly, a versionable unit of deployment for code.

“Tool,” as described herein, may refer to a multi-functional tool that may be capable of executing modules corresponding to an application, program, function, or other assemblages of programmable and executable code; intentionally perturbing, delaying, or otherwise disrupting execution of code corresponding to one or more modules; and recording and/or profiling activity of the concurrently executing modules to thereby identify potential resource usage contentions, conflicts, or race conditions in two or more assemblages of such modules.

“Resource,” as described herein, may include both physical and logical resources associated with a given computing environment. As non-limiting examples, such resources may range from files to ports to shared state; that is, any non-executable entity that may be shared by more than one executable entity.

“Threads,” as described herein, may refer to execution paths within an application, program, function, or other assemblage of programmable and executable code. Threads enable multiple paths or streams of execution of modules of executable instructions to occur concurrently within the same application, program, function, or other assemblages of programmable and executable code; whereby, within each stream, a different transaction or message may be processed. A multitasking or multiprocessing environment, in which multi-threading processes may be executed, may be found in either a managed execution environment or an unmanaged execution environment.

“Isolation boundary,” as described herein, may refer to a logical or physical construct that may serve as a unit of isolation. Processes are an example of an isolation boundary. Within a managed execution environment, such an isolation boundary may be referred to as an application domain, in which multiple threads of execution may be contained. Such terminology is provided as an example only. That is, the example implementations described herein are not limited to application domains or even to managed execution environments as stated above, but rather may be applied within various other isolation boundaries implementations in various execution environments. More particularly, isolation boundaries, as related to the scope of resource exposure described herein, may further pertain to machine boundaries, process boundaries, threads, and class or assembly boundaries. Even more particularly, the scope of resource exposure, may pertain to public/private exposure, assemblies, or classes. Further, resource exposure may have multiple axis or annotations including, e.g., a type of resource as well as visibility of the resource.

Isolation boundaries may enable the code to be executed therein to be loaded from a specified source; an isolation boundary may be aborted independent of other such isolation boundaries; and processing within an isolation boundary may be isolated so that a fault occurring therein does not affect other isolation boundaries within the process. More particularly, isolation boundaries may isolate the consumption of resources therein to the extent that other isolation boundaries either do not see any changes to a resource or, rather, see the resources in a serialized, atomic fashion.

“Code contention,” as described herein, may refer to disruptions that may occur between concurrently executing threads. A non-limiting example of such a contention is a race condition. A race condition may occur when concurrently executing threads attempt to influence or otherwise access a common resource, and the first such thread to influence or otherwise access the common resource may cause an unintended operation to be canceled, interrupted, or otherwise terminated when an application is ignorant of the processes running therein.

More particularly, a race condition may be described better by way of an example scenario in which a cancellation operation on a first thread has been called to cancel an operation to write data that may be executing on a second thread. In this example scenario, the operation executing on the second thread may either be completed or time-out before the cancel operation on the first thread is able to cancel the operation to write data on the second thread. Thus, if at least the second thread is included as part of an isolation boundary (e.g., application domain), upon the completion or the time-out of the operation to write data, the second thread may be assigned a new operation for execution. For example, the second thread may be assigned a security log operation. Thus, even though the cancel operation is intended to cancel the operation to write data on the second thread, the example scenario may end with the cancellation operation on the first thread canceling the security-based security log operation that has been newly assigned to the second thread for execution. That is, a security operation on the processor may be compromised when the original intent was to merely cancel a long-running operation to write data.

A race condition scenario is described above to introduce code contention identifier 120 by which one or more code contentions in an executing synchronous operation on a particular thread may be identified for analysis and/or correction.

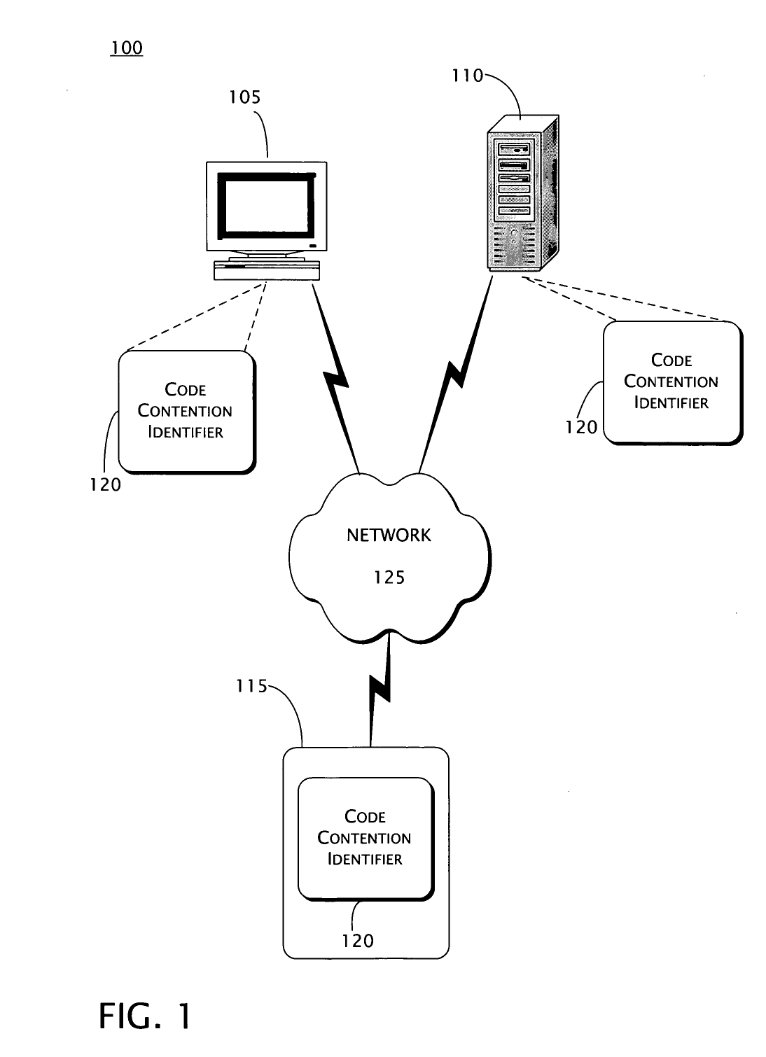

FIG. 1 shows example network environment 100 in which example technologies for a code contention identifier may be implemented, although such example technologies are in no way limited to network environments. Such technologies may include, but are not limited to, tools, methodologies, and systems, associated with code contention identifier 120, as described herein. In FIG. 1, client device 105, server device 110, and “other” device 115 may be communicatively coupled to one another via network 125; and, further, at least one of client device 105, server device 110, and “other” device 115 may be capable of the aforementioned technologies.

Client device 105 may represent at least one of a variety of known computing devices, including a desktop personal computer (PC), workstation, mainframe computer, Internet appliance, set-top box, or gaming console. Client device 105 may further represent at least one of any device that is capable of being associated with network 125 by a wired and/or wireless link, including a mobile (i.e., cellular) telephone, personal digital assistant (PDA), laptop computer, etc. Further still, client device 105 may represent the client devices described above in various quantities and/or combinations thereof. “Other” device 115 may also be embodied by any of the above examples of client device 105.

Server device 110 may represent any device that is capable of providing any of a variety of data and/or functionality to client device 105 or “other” device 115 in accordance with at least one implementation of code contention identifier 120. The data may be publicly available or alternatively restricted, e.g., restricted to only certain users or only if an appropriate subscription or licensing fee is paid. Server device 110 may be at least one of a network server, an application server, a blade server, or any combination thereof. Typically, server device 110 may represent any device that may be a content source, and client device 105 may represent any device that may receive such content either via network 125 or in an off-line manner. However, according to the example implementations described herein, client device 105 and server device 110 may interchangeably be a sending node or a receiving node in network environment 100. “Other” device 115 may also be embodied by any of the above examples of server device 110.

“Other” device 115 may represent any further device that is capable of implementing code contention identifier 120 according to one or more of the examples described herein. That is, “other” device 115 may represent any software-enabled computing or processing device that is capable of at least identifying potential code contentions associated either internally or externally of one or more isolation boundaries of an application, program, function, or other assemblage of programmable and executable code. Thus, “other” device 115 may be a computing or processing device having at least one of an operating system, an interpreter, converter, compiler, or runtime execution environment implemented thereon. These examples are not intended to be limiting in any way, and therefore should not be construed in that manner.

Network 125 may represent any of a variety of conventional network topologies and types, which may include wired and/or wireless networks. Network 125 may further utilize any of a variety of conventional network protocols, including public and/or proprietary protocols. Network 125 may include, for example, the Internet as well at least portions of one or more local area networks (also referred to, individually, as a “LAN”), such as an 802.11 system or, on a larger scale, a wide area network (i.e., WAN”); or a personal area network (i.e., PAN), such as Bluetooth.

Computer architecture in at least one of devices 105, 110, and 115 has typically defined computing platforms in terms of hardware and software. Software for computing devices has been categorized into groups, based on function, which may include: a hardware abstraction layer (alternatively referred to as a “HAL”), an operating system (alternatively referred to as “OS”), and applications.

A runtime execution environment may reside between an OS and an application, and serve as a space in which the application may execute specific tasks on any one or more of processing devices 105, 110, and 115. More particularly, a runtime execution environment may enhance the reliability of the execution of applications on a growing range of processing devices 105, 110, and 105, including servers, desktop computers, laptop computers, and mobile processing/communication devices by providing a layer of abstraction and services for an application running on such devices, and further providing the application with capabilities including memory management and configuration thereof.

A runtime execution environment may serve as at least one of an application programming and application execution platform. As an application programming platform, a runtime execution environment may compile targeted applications, which may be written in one of multiple computing languages, into an intermediate language (hereafter “IL”) or bytecode. IL is typically independent of the platform, and the central processing unit (hereafter “CPU”) executes IL. In fact, IL is a higher level language than many CPU machine languages. As an application execution platform, a runtime execution environment may interpret compiled IL into native machine instructions. A runtime execution environment may utilize either an interpreter or a compiler (e.g., “just-in-time,” alternatively “JIT,” compiler) to execute such instructions. Regardless, the native machine instructions may then be directly executed by the CPU. Since IL is CPU-independent, IL may execute on any CPU platform as long as the OS running on that CPU platform hosts an appropriate runtime execution environment. Examples of runtime environments, in which technologies associated with code contention identifier 120 may be implemented, include: Visual Basic runtime environment; Java® Virtual Machine runtime environment that is used to run, e.g., Java® routines; or Common Language Runtime (CLR) to compile, e.g., Microsoft .NET™ applications into machine language before executing a calling routine. However, this listing of runtime environments provides examples only. The example technologies described herein are not limited to just these managed execution environments. More particularly, the example implementations are not just limited to managed execution environments, for one or more examples may be implemented within testing environments and/or unmanaged execution environments.

An application compiled into IL may be referred to as “managed code,” and that is why a runtime execution environment may be alternatively referred to as a “managed execution environment.” It is noted that code that does not utilize a runtime execution environment to execute may be referred to as native code applications.

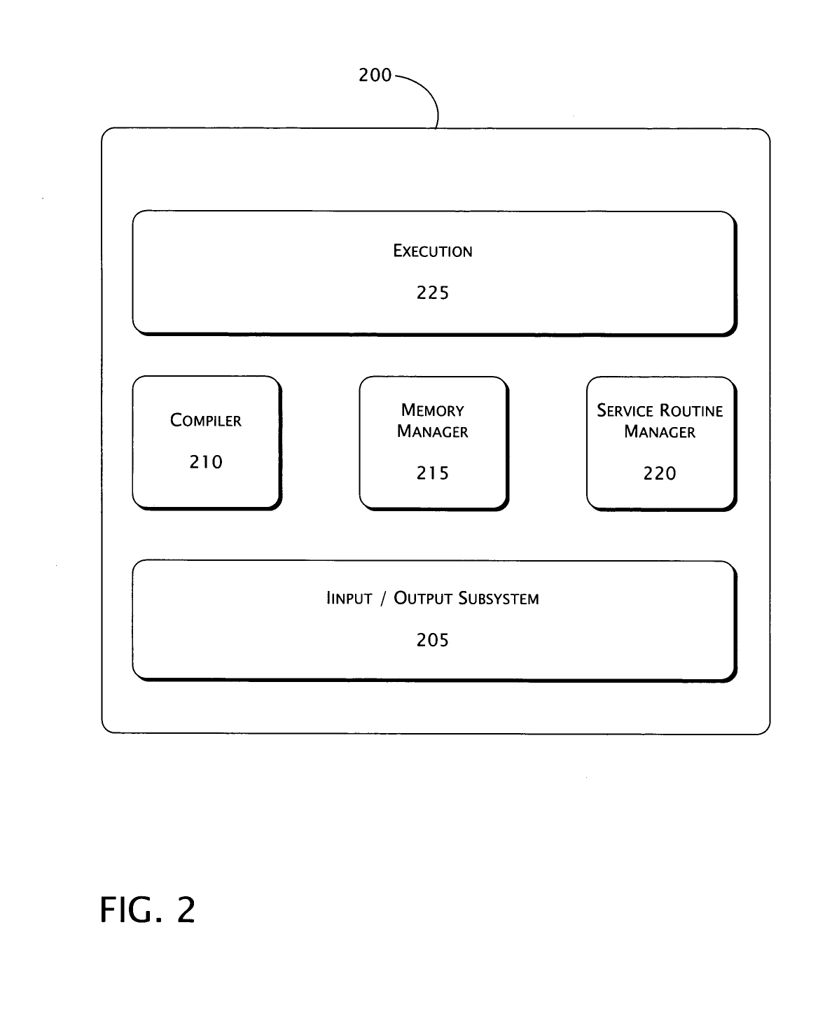

FIG. 2 shows example of runtime execution environment 200 in which technologies associated with code contention identifier 120 (see FIG. 1) may be implemented.

According to at least one example implementation, runtime execution environment 200 may facilitate execution of managed code for a computing device platform. Managed code may be considered to be part of a core set of application-development technologies, and may further be regarded as an application, program, function, or other assemblage of programmable and executable code that is compiled for execution in runtime execution environment 200 to provide a corresponding service to the computing device platform. In addition, runtime execution environment 200 may translate managed code at an interpretive level into instructions that may be proxied and then executed by a processor. Alternatively, managed code may be executed via an interpreter or a compiler, or a form of a compiler designed to run at install time as a native image. A framework for runtime execution environment 200 also provides class libraries, which may be regarded as software building blocks for managed applications.

Runtime execution environment 200 may provide at least partial functionality that may otherwise be expected from a kernel, which may or may not be lacking from a computing device platform depending upon resource constraints for a particular one of devices 105, 110, and 115 (see FIG. 1). Thus, at least one example of runtime execution environment 200 may implement the following: input/output (hereafter “I/O”) routine management, compiling, memory management, and service routine management. Thus, runtime execution environment 200 may include I/O component 205, compiler 210, at least one memory management component 215, service routine manager 225, and execution component 225. These components, which are to be described in further detail below, are provided as examples, which are not intended to be limiting to any particular implementation of runtime execution environment 200, and no such inference should be made. Thus, the components may be implemented in examples of runtime execution environment 200 in various combinations and configurations thereof.

I/O component 205 of runtime execution environment 200 may provide at least one of synchronous or asynchronous access to physical (e.g., processor and peripherals) and logical resources (e.g., drivers, or physical resources partitioned in a particular manner) associated with the computing device platform. More particularly, I/O component 205 may provide runtime execution environment 200 with robust system throughput and further streamline performance of code from which an I/O request originates.

Compiler 210 may refer to a module within runtime execution environment 200 that may interpret compiled IL into native machine instructions for execution in runtime execution environment 200. Further, in accordance with at least one alternative implementation of technologies associated with code contention identifier 120, compiler 210 may dynamically analyze, for various purposes, the behavior of code modules associated with an application, program, function, or other assemblage of programmable and executable code. The code modules may or may not be loaded into runtime execution environment 200. If the code modules are loaded into runtime execution environment 200, the analysis may include identifying the potential for one or more code contentions between two or more concurrently executing execution paths (e.g., threads), either internally or externally of an isolation boundary; profiling the two or more execution paths within a predetermined time radius of a deliberate perturbance to the execution of at least one of the concurrently executing execution paths; and identifying how a particular physical or logical resource that is subject to the potential code contention may be used by the two or more execution paths based on an analysis of execution of the concurrently executing execution paths at the time of the perturbance. The analysis may be performed without touching or affecting an executable portion of the code modules, and may be performed at compile time, initial runtime, or at any time thereafter during execution of an executable portion of the execution paths.

Memory management component 215 may be referred to as a “garbage collector,” which implements garbage collection. Garbage collection may be regarded as a robust feature of managed code execution environments by which an object is automatically freed (i.e., de-allocated) if, upon a sweep or scan of a memory heap, an object is determined to no longer be used by an application, program, function, or other assemblage of programmable and executable code. Further functions implemented by memory management component 215 may include: managing one or more contiguous blocks of finite volatile RAM (i.e., memory heap) storage or a set of contiguous blocks of memory amongst the tasks running on the computing device platform; allocating memory to at least one application, program, function, or other assemblage of programmable and executable code running on the computing device platform; freeing at least portions of memory on request by at least one of the applications, programs, functions, or other assemblages of programmable and executable code; and preventing any of the applications, programs, functions, or other assemblages of programmable and executable code from intrusively accessing memory space that has been allocated to any of the other applications, programs, functions, or other assemblages of programmable and executable code.

Service routine manager 220 may be included as at least a portion of an application support layer to provide services functionality for physical and logical resources associated with the computing device platform. Example technologies (e.g., tools, methodologies, and systems) associated with code contention identifier 120 may be managed by service routine manager 220. That is, such technologies may be implemented either singularly or in combination together by compiler 210 (as referenced above), service routine manager 220, or some other component of runtime execution environment 200, in accordance with various alternative implementations of such technologies. For example, in at least one example implementation, service routine manager 220 may at least contribute to deliberately altering the timing of execution of one or more concurrently executing execution paths (e.g., threads), profiling the concurrently executing execution paths within a predetermined time radius of the point at which execution of at least one of the execution paths has been altered, and determining how a particular physical or logical resource may be used by the two or more execution paths (i.e., identifying a race condition). Such contribution may be made without touching or affecting an executable portion of the code modules, at compile time, initial runtime, or at any time thereafter during execution of an executable portion of the code modules.

Execution component 225 may enable execution of managed code for the computing device platform. More particularly, with regard to implementation of technologies associated with code contention identifier 120, execution component 225 may serve as an exemplary component within runtime execution environment 200 that may implement one or more of the tools, systems, and processes for identifying code contentions among two or more execution paths and profiling the execution paths.

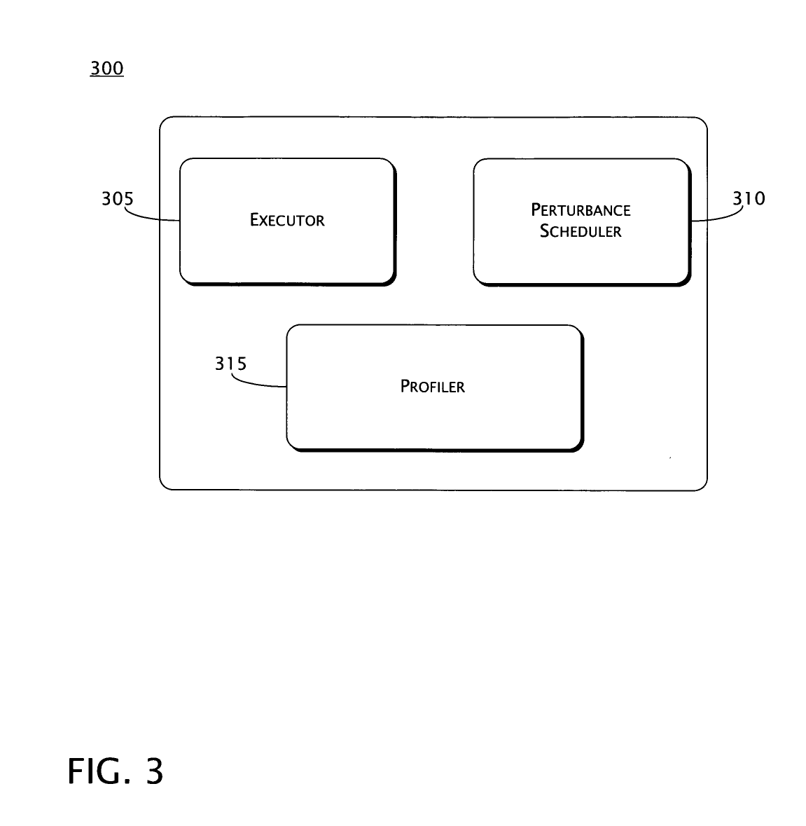

FIG. 3 shows example code contention identifying tool 300 implemented as an example technology associated with code contention identifier 120 (see FIG. 1).

In the following description, various operations will be described as being performed by various modules associated with code contention identifying tool 300. The various operations that are described with respect to any particular one of these modules may be carried out by the module itself, in combination with another one of the modules, or by the particular module in cooperation with other components of runtime execution environment 200. In addition, the operations of each of the modules of code contention identifying tool 300 may be executed by a processor or processors (see FIG. 1) and implemented as hardware, firmware, or software, either singularly or in various combinations together.

Example implementations of code contention identifying tool 300 may be implemented in an off-line manner, separate from any of the components of runtime execution environment 200. However, at least one alternative implementation of code contention identifying tool 300 may be incorporated with any of a portion of compiler 210, service routine manager 220, or some other component of runtime execution environment 200, either singularly or in combination together. In such alternative implementation, code contention identifying tool 300 may be executed or processed by execution component 225. Regardless, code contention identifying tool 300 may be utilized at least: to perturb deliberately, or to alter the timing of, the execution of at least one of multiple concurrently executing execution paths; compare the performance of the execution paths at, or near, the time of the deliberate perturbance; identify potential code contentions (e.g., race conditions) between two or more concurrently executed execution paths (e.g., threads) based on the comparison; and determine how a physical or logical resource that may be subject to the potential code contention may be used by the two or more execution paths. The two or more execution paths, and therefore the aforementioned potential code contentions, may exist among either the same or multiple versions of a same application, program, function, or other assemblage of programmable and executable code, which may or may not exist within the same isolation boundary.

Executor 305 may represent a module within code contention identifying tool 300 to execute one or more instructions included in the modules of concurrently executing execution paths (e.g., threads) corresponding to an application, program, function, or other assemblage of programmable and executable code that is submitted to code contention identifying tool 300.

Perturbance scheduler 310 may represent a module within code contention identifying tool 300 to schedule, or otherwise inject, one or more perturbances within execution of the modules of at least one of the concurrently executing execution paths submitted to code contention identifying tool 300. The perturbances may include a set of instructions that are intended to produce a delay in the execution of at least a portion of a corresponding execution path.

The scheduling of one or more perturbances may be permitted in accordance with an annotation corresponding to a respective one of the execution paths. Examples of annotations (i.e., constructs) that may affect such perturbances include, but are in no way limited to: a loop of instructions to spin busy, a loop of instructions to repeatedly perform an I/O operation, a loop of instructions to call a kernel function, a sleep statement, and a yield statement. Such an annotation may be incorporated within, for example, a contract that may otherwise make declarations within a respective one of the execution paths. Contract macros may exist at synchronization points, which is where cooperative issues among two or more concurrently executing execution paths may occur. Therefore, according to at least one example implementation of code contention identifier 120, contract macros may be used to inject, or otherwise deliberately schedule, perturbances into at least one of concurrently executing execution paths, in cooperation with perturbance scheduler 310.

The perturbances scheduled by module 310 may include intentionally delaying execution of one or more instructions included in the modules of concurrently executing execution paths (e.g., threads) corresponding to an application, program, function, or other assemblage of programmable and executable code that are submitted to code contention identifying tool 300.

An example of such perturbances may include a random delay as permitted in accordance with an annotation corresponding to a respective one of the execution paths. That is, based on the annotation, execution of one or more of the modules within a respective execution path may be intentionally delayed. The random delay, an example of which may be applied up to 100⁻³ seconds, may roughly model random system noise. More particularly, one or more such random delays may be scheduled or injected in the execution of modules in an execution path in an effort to expose code contentions (e.g., race conditions) that may exist among two or more concurrently executing execution paths in certain processing environments. Even more particularly, by delaying execution of a specified module, and effectively mimicking the unintentional cancellation, interruption, or termination of an operation, one or more race conditions that may exist between the specified module and one or more modules on a concurrently executing execution path may be exposed.

The aforementioned intentional delays may be regarded as “random” in more than one sense. For example, the randomness of the delay may indicate that the length of time by which execution of a specified module within one of the concurrently executing execution path is delayed may be variably adjusted. Such adjustments to the delay may be set by the author of the module and, therefore, included in the annotation; or the adjustments may be set by a module corresponding to runtime execution environment 200 (e.g., service routine manager 220). As a further example, the randomness of the delay may refer to the slots in which the delay is injected into an execution path. That is, in accordance with an annotation corresponding to a respective one of the execution paths, execution of one or more modules in the respective execution paths may be delayed every n^{th} (n is an integer>0) occurrence. Further, even the delays that are scheduled for every n^{th} occurrence may be variably adjusted in accordance with the corresponding annotation. This type of delay, which may be referred to as a slotted delay, may give the appearance of a page fault delay.

Another example of the aforementioned perturbances may include, in accordance with an annotation corresponding to a respective one of the execution paths, a respective one of the concurrently executing execution paths yielding control to another. Thus, the execution path that has been yielded to, may execute continuously to effectively race ahead of one or more of the other execution paths that would otherwise be executed concurrently. Accordingly, synchronization issues (i.e., code contentions) that are beyond normal changes in execution order may be exposed. In at least one alternative implementation, again based upon the aforementioned annotation, different ones of multiple concurrently executing execution paths may be yielded to for execution until blocked. Then, another one of the execution paths may be selected as the chosen, or yielded to, execution path that may execute continuously until blocked.

Profiler 315 may represent a module within code contention identifying tool 300 to receive data from an execution path (e.g., thread) that may be used to create a profile of at least partial execution on that execution path. The data received may include a time at which a perturbance occurs on a particular execution path. The time at which a perturbance may occur or may be recorded, according to the implementations described herein, may be either absolute time or relative time. Absolute time may be regarded as common chronological time common to all modules and execution paths within a running application, program, function, or other assemblage of programmable and executable code; and relative time may be regarded as the relative time at which a module in a particular execution path is executed in relation to execution of one or more modules in at least one other concurrently executing execution path.

The data received by profiler 315 may further include state for the particular execution path preceding and following the perturbance, in accordance with a predetermined time frame. Subsequently, profiler 315 may compare profiles of multiple, concurrently executing execution paths to determine the state of each execution path as a perturbance occurs on any particular one of the concurrently executing execution paths. Thus, profiler 315 may enable a re-creation of the execution of one or more of the execution paths in an effort to remedy any code contentions revealed by the received profiles.

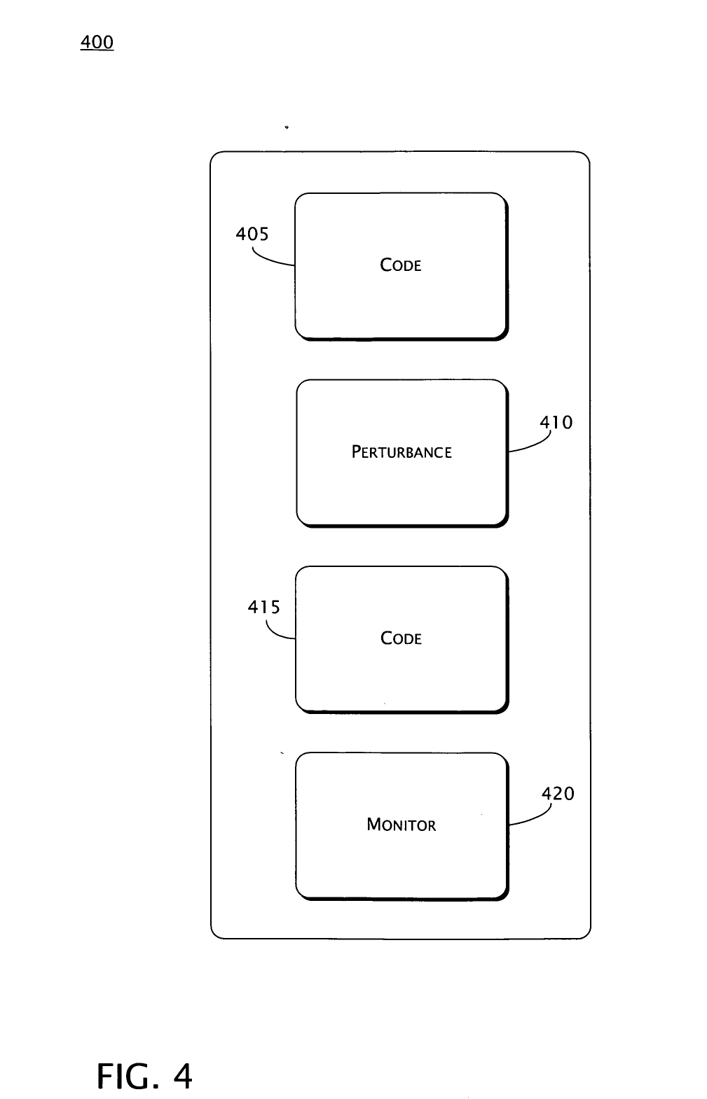

FIG. 4 shows example execution path (e.g., thread) 400, which may be the subject of an implementation of example technologies associated with code contention identifier 120 (see FIG. 1).

Operations performed on at least portions of example execution path 400 are described as being performed by various modules associated with code contention identifying tool 300 (see FIG. 3). The various operations that are described with respect to any particular one of these modules may be carried out by the module itself, in combination with another one of the modules, or by the particular module in cooperation with other components of runtime execution environment 200.

Modules 405 and 415 may refer to modules of executable instructions corresponding to an application, program, function, or other assemblage of programmable and executable code.

Perturbance 410 may refer to one or more modules of executable instructions that are intended to produce a delay in the execution of at least a portion of a corresponding execution path. The placement of perturbance 410 into execution path 400 may result from scheduling by scheduler 310 of code contention identifying tool 300.

Information regarding perturbance 410, including scheduling information and instructions, may be incorporated separately or collectively within one or more annotations or constructs corresponding to example execution path 400. Examples of perturbance 410 may include, separately or collectively: a loop of instructions to spin busy, a loop of instructions to repeatedly perform an I/O operation, a loop of instructions to call a kernel function, a sleep statement, and a yield statement. Further, perturbance 410 may be incorporated within a construct at a synchronization point, which is where cooperative issues among two or more concurrently executing execution paths may occur. Therefore, according to example execution path 400, perturbance 410 may be included in a construct including, but not limited to, a contract macro at the edge of executable module 415.

More particularly, execution of instructions corresponding to executable module 415 may be perturbed (e.g., delayed, spun, or yielded) for a variably adjustable amount of time or until a specified event occurs. That is, perturbance 410 may include delaying execution of module 415 or yielding execution of module 415 until a concurrently executing execution path has been blocked, completed, or otherwise terminated. Alternative implementations of code contention identifying tool 300 may even yield execution of execution path 400 entirely until a concurrently executing execution path has been blocked, completed, or otherwise terminated.

Monitor 420 may represent a module within example execution path 400 to monitor performance of the modules of executable code in execution path 400 for a predetermined amount of time before, during, and after perturbance 410 has been executed. In particular, monitor 420 may record the time at which perturbance 410 is executed, and the recorded time may be an absolute exact time or a relative exact time based on requirements of code contention identifying tool 300. Further, monitor 420 may record state corresponding to execution path 400 for the predetermined amount of time before, during, and after perturbance 410 has been executed. Further still, monitor 420 may provide the data recorded therein to profiler 315 of code contention identifying tool 300 where recorded data from concurrently executing execution paths may be compared and contrasted with an intention to identify and rectify code contentions among the concurrently executing, or executed, execution paths.

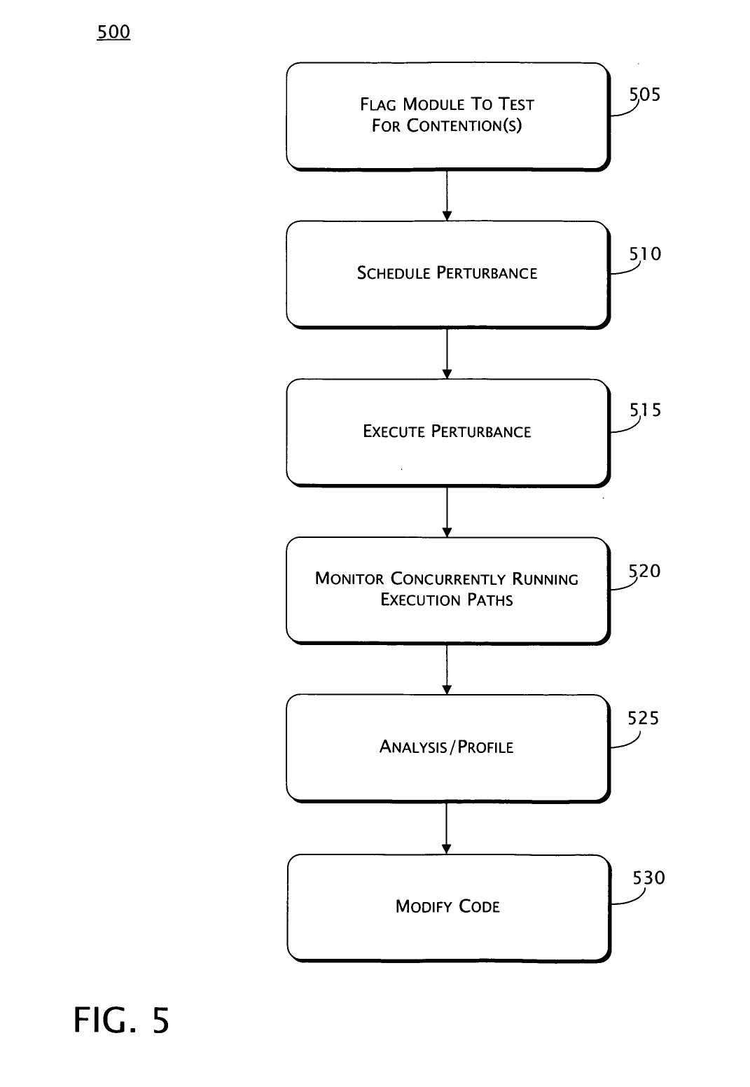

FIG. 5 shows example processing flow 500 implemented in accordance with an example technology associated with code contention identifier 120 (see FIG. 1). More particularly, processing flow 500 may be implemented by the example tool of FIG. 3.

Processing flow 500 may be described with reference to the features and characteristics described above with regard to runtime execution environment 200 (see FIG. 2), example code contention identifying tool 300 (see FIG. 3), and example execution path 400 (see FIG. 4).

Block 505 may refer to an author of one or more executable modules 405 and 415 flagging or otherwise annotating execution path 400 to indicate which module or executable method is to be perturbed. The flagging may be implemented as an annotation (e.g., contract macro) or as some other construct indicating a point of processing corresponding to execution path 400 at which execution is to be perturbed. Instructions for the perturbing may be incorporated within the flagging or may be provided separately. The instructions may include, separately or collectively: a loop of instructions to spin busy, a loop of instructions to repeatedly perform an I/O operation, a loop of instructions to call a kernel function, a sleep statement, and a yield statement.

Block 510 may refer to perturbance scheduler 310 scheduling, or otherwise injecting, one or more perturbances 410 into the execution of execution path 400 as flagged at block 505.

Block 515 may refer to one or more perturbances 410 being executed at the flagged or otherwise annotated point, during execution of execution path 400.

Block 520 may refer to monitor 420 recording data pertaining to execution at block 515. More particularly, block 520 may refer to monitor 420 recording an absolute- or relatively exact time at which perturbance 410 is executed and state corresponding to execution path 400 for a predetermined amount of time before, during, and after perturbance 410 has been executed.

Block 525 may refer to profiler 315 of code contention identifying tool 300 receiving data recorded by monitor 420 in execution path 420 as well as other concurrently executing execution paths. Thus, block 525 may further refer to profiler 315 creating a profile of the execution of two or more concurrently executing execution paths corresponding to an application, program, function, or other assemblage of programmable and executable code by identifying any disruptions in one or more of the concurrently executed execution paths resulting from the deliberate perturbance, which may mimic an unintentional cancellation, interruption, or termination of an operation in one or more of the other execution paths.

Block 530 may refer to an author of the application, program, function, or other assemblage of programmable and executable code to which execution path 400 and the concurrently executing execution paths correspond, identifying and addressing any code contentions identified based on a profile produced at block 525. Various implementations may include such identification and corrective measures being taken by a code author, one or more tools corresponding to runtime execution environment 200.

By the description above, pertaining to FIGS. 1-5, one or more potential code contentions (e.g., race conditions) among two or more execution paths (e.g., threads) may be identified with at least the intention of pre-empting the contention in at least a managed execution environment. However, the example implementations described herein are not limited to just the environment of FIG. 1, the components of FIGS. 2 and 3, an execution path as in FIG. 4, or the process of FIG. 5. Technologies (e.g., tools, methodologies, and systems) associated with code contention identifier 120 (see FIG. 1) may be implemented by various combinations of the components described with reference to FIGS. 2-4, as well as in various orders of the blocks described with reference to FIG. 5.

Further, the computer environment for any of the examples and implementations described above may include a computing device having, for example, one or more processors or processing units, a system memory, and a system bus to couple various system components.

The computing device may include a variety of computer readable media, including both volatile and non-volatile media, removable and non-removable media. The system memory may include computer readable media in the form of volatile memory, such as random access memory (RAM); and/or non-volatile memory, such as read only memory (ROM) or flash RAM. It is appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electric erasable programmable read-only memory (EEPROM), and the like, can also be utilized to implement the example computing system and environment.

Reference has been made throughout this specification to “an example,” “alternative examples,” “at least one example,” “an implementation,” or “an example implementation” meaning that a particular described feature, structure, or characteristic is included in at least one implementation of the present invention. Thus, usage of such phrases may refer to more than just one implementation. Furthermore, the described features, structures, or characteristics may be combined in any suitable manner in one or more implementations.

One skilled in the relevant art may recognize, however, that code module initialization may be implemented without one or more of the specific details, or with other methods, resources, materials, etc. In other instances, well known structures, resources, or operations have not been shown or described in detail merely to avoid obscuring aspects of the invention.

While example implementations and applications of the code module initialization have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the invention, as both described above and claimed below.

We claim:

1. A computer-readable medium having one or more execution paths, at least one of the execution paths comprising:
modules to execute one or more programmable instructions;
a delay construct to alter timing of the execution of one or more of the modules; and
a monitor to track a delay in execution of one or more of the modules.

2. A computer-readable medium according to claim 1, wherein the one or more execution paths include concurrently executing threads.

3. A computer-readable medium according to claim 1, wherein the delay construct is incorporated in a contract macro.

4. A computer-readable medium according to claim 1, wherein the delay construct injects a variably-adjustable delay into the at least one execution path.

5. A computer-readable medium according to claim 1, wherein the delay construct injects a variable-adjustable delay into the at least one execution path to enable another of the execution paths to execute without delay.

6. A computer-readable medium according to claim 1, wherein the at least one execution path is selected at a designated interval among multiple execution paths, and wherein further the delay construct injects a variably-adjustable delay into the at least one execution path.

7. A computer-readable medium according to claim 1, wherein the delay construct injects a variably-adjustable delay into the at least one execution path, and wherein further the monitor records at least a time at which the delay construct is injected into the at least one execution path.

8. A computer-readable medium according to claim 1, wherein the monitor records a status of one or more of the execution paths within a predetermined time frame preceding and following injection of a delay from the delay construct into the one or more execution paths.

9. A method, comprising:
scheduling a delay in at least one of plural concurrent execution paths in an execution system;
executing the scheduled delay; and
monitoring performance on the concurrent execution paths for a predetermined time after executing the scheduled delay.

10. A method according to claim 9, wherein the execution system is a managed execution environment.

11. A method according to claim 9, further comprising recording at least a time at which a perturbance occurs in at least one of the concurrent execution paths.

12. A method according to claim 9, wherein the scheduling is implemented in a particular one of the concurrent execution paths for a variable amount of time from a designated range.

13. A method according to claim 9, wherein the scheduling is implemented in every n^{th} one of the concurrent execution paths, wherein further “n” is an integer.

14. A method according to claim 9, wherein the scheduling is implemented by injecting a delay construct into one or more of the concurrent execution paths within a predetermined range of code.

15. A method according to claim 9, wherein the monitoring includes recording an occurrence of one or more perturbances in at least one of the concurrent execution paths.

16. A method according to claim 9, wherein the monitoring includes recording at least a time corresponding to an occurrence of one or more perturbances in at least one of the concurrent execution paths.

17. A method according to claim 9, wherein the monitoring includes recording at least a length and place of occurrence of one or more perturbances in at least one of the concurrent execution paths.

18. A system, comprising:
means for causing a delay in an execution path in an execution system;
means for monitoring concurrently executing execution paths in the execution system; and
means for recording an occurrence of altered execution timing for at least one of the concurrently executing execution paths.

19. A system according to claim 18, wherein the means for causing a delay includes a contract macro.

20. A system according to claim 18, wherein the means for recording further records at least a length and place of occurrence of the contention.
